(19) United States
(12) Patent Application Publication
(10) Pub. No.: US 2024/0051338 A1
(43) Pub. Date: Feb. 15, 2024

(54) PNEUMATIC TIRE

(71) Applicant: The Yokohama Rubber Co., LTD., Tokyo (JP)

(72) Inventors: Ayaki KAZARIYA, Kanagawa (JP); Makoto OZAKI, Kanagawa (JP); Hideaki SAWA, Kanagawa (JP)

(21) Appl. No.: 18/260,295

(22) PCT Filed: Dec. 24, 2021
(86) PCT No.: PCT/JP2021/048184

§ 371 Date: Jul. 18, 2023

(30) Foreign Application Priority Data
Jan. 8, 2021 (JP) 2021-002003

(51) Int. Cl. B60C 1/00; B60C 11/00; C08L 9/06

(52) U.S. Cl. CPC B60C 1/0016; B60C 11/005; B60C 11/0008; C08L 9/06; B60C 2011/0025; C08L 2205/03

(57) ABSTRACT

For a cap tread layer of a pneumatic tire, a rubber composition is used, which contains from 60 to 90 parts by mass of silica per 100 parts by mass of a diene rubber containing from 15 to 30 mass % of a natural rubber, from 40 to 70 mass % of a terminal-modified styrene-butadiene rubber having a vinyl content of from 35 to 45 mass %, and from 15 to 30 mass % of a modified butadiene rubber obtained by modifying an active terminal of a conjugated diene polymer with at least a hydrocarbyloxysilane compound, the total of these being 100 mass %. A hardness Hu of the undertread Layer and a hardness Hc of the cap tread layer satisfy the relationship of Hu>Hc. The hardness Hc is 63 or greater and 67 or less. A difference ΔH between the hardness Hu and the hardness Hc is 10 or more.

### TECHNICAL FIELD

The present technology relates to a pneumatic tire mainly intended for use as an all-season tire.

### BACKGROUND ART

So-called all-season tires, which are intended to be used under various weather conditions throughout the year, are required to exhibit excellent running performance not only on normal dry road surfaces but also on wet road surfaces in rainy weather and snowy road surfaces in winter (e.g., see Japan Unexamined Patent PublicationNo. 2015-229701 A). That is, for example, steering stability performance on dry road surfaces (hereinafter, referred to as dry performance), braking performance on wet road surfaces (hereinafter, referred to as wet performance), and braking performance on snowy road surfaces (hereinafter, referred to as snow performance) are required to be provided in a highly compatible manner. In addition, improvement of fuel economy performance (reducing rolling resistance) during travel has been demanded to reduce the environmental impact.

However, even when improvement of these performances is attempted by a rubber (tread rubber) constituting a tread portion of a pneumatic tire, because these performances conflict with each other, these performances are difficult to be provided in a compatible manner to a high degree. For example, as a method of providing a rubber having excellent dry performance and wet performance, a method of increasing tan δ at 0° C. is known; however, when the tan δ at 0° C. increases, tan δ at 60° C. also increases, and the rolling resistance cannot be reduced. Furthermore, increasing of the tan δ at 0° C. increases a glass transition temperature Tg, and deterioration of the snow performance is also concerned. Alternatively, as a method of providing a rubber having excellent snow performance, a method of increasing a blended amount of a butadiene rubber is known; however, dispersibility of silica deteriorates due to the increase of the blended amount of the butadiene rubber, the reduction of rolling resistance may be difficult. Thus, measures to reduce rolling resistance while dry performance, wet performance, and snow performance are improved in a well-balanced manner by adjustment of compounding proportions or physical properties of a tread rubber, and to provide these performances in a compatible manner to a high degree have been demanded.

### SUMMARY

The present technology provides a pneumatic tire that has reduced rolling resistance and improved dry performance, wet performance, and snow performance and that is capable of providing these performances in a compatible manner to a high degree.

A pneumatic tire according to an embodiment of the present technology includes:
a tread portion extending in a tire circumferential direction and having an annular shape;
a pair of sidewall portions disposed on both sides of the tread portion;
a pair of bead portions disposed on an inner side in a tire radial direction of the pair of sidewall portions;
a carcass layer mounted between the pair of bead portions; and
a plurality of reinforcing layers disposed on an outer circumferential side of the carcass layer in the tread portion;
the tread portion having a bilayer structure including an undertread layer disposed on an outer circumferential side of the reinforcing layer and a cap tread layer disposed on an outer circumferential side of the undertread layer and constituting a road contact surface of the tread portion;
the cap tread layer including a rubber composition containing from 60 parts by mass to 90 parts by mass of silica, per 100 parts by mass of a diene rubber containing 15 mass % or greater and 30 mass % or less of a natural rubber, 40 mass % or greater and 70 mass % or less of a styrene-butadiene rubber, and 15 mass % or greater and 30 mass % or less of a butadiene rubber, a total of the natural rubber, the styrene-butadiene rubber, and the butadiene rubber being 100 mass %;
the styrene-butadiene rubber being a terminal-modified styrene-butadiene rubber having a vinyl content of from 35 mass % to 45 mass %;
the butadiene rubber being a modified butadiene rubber obtained by modifying an active terminal of a conjugated diene polymer with at least one functional group selected from the group consisting of a hydrocarbyloxysilane compound and a polyorganosiloxane;
a hardness Hu of an undertread rubber constituting the undertread layer at 20° C. and a hardness Hc of a cap tread rubber constituting the cap tread layer at 20° C. satisfying a relationship of Hu>Hc;
the hardness Hc being 63 or greater and 67 or less; and
a difference ΔH between the hardness Hu and the hardness Hc being 10 or more.

In the pneumatic tire according to an embodiment of the present technology, a tread portion has a bilayer structure including a cap tread layer and an undertread layer, the cap tread layer contains a rubber composition having the compounding proportions described above, and the relationship between the hardness of the cap tread rubber and the hardness of the undertread rubber is set as described above, and thus dry performance and wet performance are improved while snow performance is satisfactorily exhibited, and rolling resistance can be reduced. Note that, in an embodiment of the present technology, the “hardness” of each rubber is a value measured by using a Type A durometer at a temperature of 20° C. in accordance with JIS (Japanese Industrial Standard) K 6253.

In an embodiment of the present technology, a cis-1,4 bond content in the butadiene rubber is preferably 75 mol % or greater. Consequently, characteristics of the butadiene rubber in the rubber composition constituting the cap tread layer becomes excellent, and thus this is advantageous for reducing rolling resistance while dry performance, wet performance, and snow performance are improved. Note that the “cis-1,4 bond content” refers to a proportion (mol %) of repeating units having a cis-1,4 bond among all repeating units derived from butadiene.

In an embodiment of the present technology, a storage modulus E′ of the cap tread rubber constituting the cap tread layer at −20° C. is preferably 70 MPa or less. Accordingly, this is advantageous for improving snow performance. Note that, in an embodiment of the present technology, the “storage modulus E′ at −20° C.” refers to a value measured by using a viscoelastic spectrometer under the conditions of an elongation deformation strain of 10±2%, a vibration frequency of 20 Hz, and −20° C.

In an embodiment of the present technology, the undertread layer preferably contains, per 100 parts by mass of a rubber component containing two or more types selected from the group consisting of a natural rubber, a styrene-butadiene rubber, an isoprene rubber, and a butadiene rubber, a rubber composition containing 70 parts by mass or greater of silica or carbon black, and the hardness Hu of the undertread rubber at 20° C. is preferably 75 or greater and 80 or less. Consequently, physical properties of the undertread layer becomes even better and, in particular, the hardness of the undertread rubber is properly set. Thus, this is advantageous for reducing rolling resistance while dry performance, wet performance, and snow performance are improved.

In an embodiment of the present technology, a ratio h/G of a block height h from a groove bottom of a groove formed in the tread portion to a road contact surface of the tread portion to a thickness G of the undertread layer is preferably from 9 to 12. Consequently, structures (rubber gauges) of the cap tread layer and the undertread layer are properly set. Thus, this is advantageous for reducing rolling resistance while dry performance, wet performance, and snow performance are improved.

### BRIEF DESCRIPTION OF DRAWINGS

FIG. 1 is a meridian cross-sectional view illustrating an example of a pneumatic tire of an embodiment of the present technology.

FIG. 2 is an enlarged explanatory diagram illustrating the tread portion of FIG. 1.

### DETAILED DESCRIPTION

Configurations of embodiments of the present technology will be described in detail below with reference to the accompanying drawings.

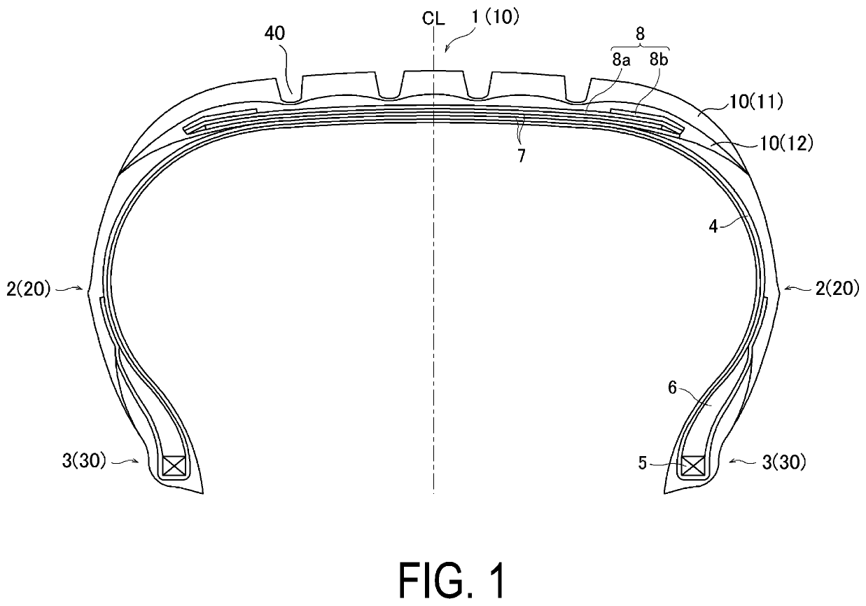

As illustrated in FIG. 1, a pneumatic tire of an embodiment of the present technology includes a tread portion 1, a pair of sidewall portions 2 respectively disposed on both sides of the tread portion 1, and a pair of bead portions 3 disposed on an inner side in a tire radial direction of the sidewall portions 2. Note that “CL” in FIG. 1 denotes a tire equator. Although not illustrated in FIG. 1 that is a meridian cross-sectional view, the tread portion 1, the sidewall portions 2, and the bead portions 3 each extend in the tire circumferential direction and have an annular shape, forming a basic structure of a toroidal shape of the pneumatic tire. Although the description using FIG. 1 is basically based on the illustrated meridian cross-sectional shape, all of the tire components extend in the tire circumferential direction and form the annular shape.

A carcass layer 4 is mounted between the left-right pair of bead portions 3. The carcass layer 4 includes a plurality of reinforcing cords (carcass cords) extending in the tire radial direction and covered with a coating rubber and is folded back around a bead core 5 disposed in each of the bead portions 3 from an inner side to an outer side in a tire width direction. A bead filler 6 is disposed on an outer periphery of the bead core 5, and the bead filler 6 is enveloped by a body portion and a folded back portion of the carcass layer 4.

In an example of FIG. 1, a plurality of belt layers 7 (two layers) are provided on an outer circumferential side of the carcass layer 4 in the tread portion 1. Each of the belt layers 7 includes a plurality of reinforcing cords (belt cords) inclining with respect to the tire circumferential direction, with the belt cords of the layers intersecting each other. In the belt layers 7, an inclination angle of the belt cord with respect to the tire circumferential direction is set within a range, for example, from 10° to 40°. As the belt cord, for example, a steel cord can be used.

In an example of FIG. 1, a plurality of belt cover layers 8 (two layers) is provided on an outer circumferential side of the belt layer 7. Note that, of the two belt cover layers 8 of an illustrated example, one is a full cover layer 8a that covers the entire region of the belt layer 7, and the other is a pair of edge cover layers 8b that locally cover both end portions of the belt layers 7. The belt cover layer 8 includes a reinforcing cord (belt cover cord) oriented in the tire circumferential direction. In the belt reinforcing layer 8, an angle of the belt cover cord with respect to the tire circumferential direction is set to, for example, from 0° to 5°. As the belt cover cord, for example, an organic fiber cord can be used.

In an embodiment of the present technology, these belt layers 7 and the belt cover layers 8 may hereinafter collectively be referred to as a reinforcing layer. In an embodiment of the present technology, as the reinforcing layer, only the belt layers 7 may be provided, or both of the belt layers 7 and the belt cover layers 8 may be provided. The “outer circumferential side of reinforcing layer” in the description below means an outer circumferential side of a belt layer 7 (especially, an outermost layer of the plurality of belt layers 7 in the tire radial direction) in a case where only the belt layers 7 are provided, or means an outer circumferential side of a belt cover layer 8 (especially, an outermost layer of the plurality of belt cover layers 8 in the tire radial direction) in a case where the belt layers 7 and the belt cover layers 8 are provided.

In the tread portion 1, a tread rubber layer 10 is disposed on the outer circumferential side of the above-mentioned carcass layer 4 and reinforcing layer (the belt layers 7 and the belt cover layers 8). In an embodiment of the present technology, the tread rubber layer 10 has a structure in which two types of rubber layers having different physical properties (a cap tread layer 11 and an undertread layer 12) are layered in the tire radial direction. The cap tread layer 11 is disposed on outer circumferential side of the undertread layer 12 and constitutes a road contact surface of the tread portion 1. The undertread layer 12 is sandwiched between the cap tread layer 11 and the reinforcing layer. A side rubber layer 20 is disposed on the outer circumferential side (the outer side in the tire width direction) of the carcass layer 4 in the sidewall portion 2, and a rim cushion rubber layer 30 is disposed on the outer circumferential side (the outer side in the tire width direction) of the carcass layer 4 in the bead portion 3.

An embodiment of the present technology relates to the tread portion 1 (the cap tread layer 11 and the undertread layer 12), and thus other portions and constituent members are not limited to the structure described above. Note that, in the following description, a rubber composition constituting the cap tread layer 11 may be referred to as a cap tread rubber, and a rubber composition constituting the undertread layer 12 may be referred to as an undertread rubber.

In the rubber composition constituting the cap tread layer 11, the rubber component contains indispensably three types of components that are a natural rubber, a styrene-butadiene rubber, and a butadiene rubber, and the total of these is 100 mass %. In an embodiment of the present technology, combined use of these three types of rubbers in the proportions described below allows snow performance, wet performance, and rolling resistance to be improved.

The natural rubber is not particularly limited as long as the natural rubber is typically used for rubber compositions for tires. Blending of the natural rubber allows snow performance to be further enhanced. A content of the natural rubber is 15 mass % or greater and 30 mass % or less, and preferably from 17 mass % to 25 mass %, per 100 mass % of the diene rubber. When the content of the natural rubber is less than 15 mass %, snow performance cannot be sufficiently improved. When the content of the natural rubber is more than 30 mass %, the improvement effect of wet performance and rolling resistance cannot be achieved.

The styrene-butadiene rubber used in an embodiment of the present technology is a terminal-modified styrene-butadiene rubber having a vinyl content of from 35 mass % to 45 mass %, and preferably from 38 mass % to 43 mass %. Use of such a terminal-modified styrene-butadiene rubber allows wet performance and low rolling resistance to be improved. The type of the modification group in the terminal-modified styrene-butadiene rubber is not particularly limited as long as the vinyl content satisfies the condition described above, and examples thereof include an epoxy group, a carboxy group, an amino group, a hydroxy group, an alkoxy group, a silyl group, an alkoxysilyl group, an amide group, an oxysilyl group, a silanol group, an isocyanate group, an isothiocyanate group, a carbonyl group, and an aldehyde group. Among these modification groups, a hydroxy group, an alkoxysilyl group, and an amide group can be suitably used.

A content of the styrene-butadiene rubber is 40 mass % or greater and 70 mass % or less, and preferably from 55 mass % to 65 mass %, per 100 mass % of the diene rubber. When the content of the styrene-butadiene rubber is less than 40 mass %, wet performance deteriorates. When the content of the styrene-butadiene rubber is more than 70 mass %, snow performance deteriorates.

The butadiene rubber used in an embodiment of the present technology is a modified butadiene rubber obtained by modifying an active terminal of a conjugated diene polymer with at least one functional group selected from the group consisting of a hydrocarbyloxysilane compound and a polyorganosiloxane. Note that examples of the hydrocarbyloxysilane compound include N,N-bis(trimethylsilyl)-3-aminopropyltrimethoxysilane, N,N-bis(trimethylsilyl)-3-aminopropyltriethoxysilane, N,N-bis(trimethylsilyl)aminoethyltrimethoxysilane, and N,N-bis(trimethylsilyl)aminoethyltriethoxysilane. A cis-1,4 bond content in the modified butadiene rubber is preferably 75 mol % or greater, and more preferably 90 mol % or greater. With use of such a modified butadiene rubber, affinity to silica described below can be increased, dispersibility can be improved, thus the effect of silica is improved, and low rolling performance and wet performance can be improved.

A content of the butadiene rubber is 15 mass % or greater and 30 mass % or less, and preferably from 17 mass % to 25 mass %, per 100 mass % of the diene rubber. When the content of the butadiene rubber is less than 15 mass %, snow performance deteriorates. When the content of the butadiene rubber is more than 30 mass %, wet performance deteriorates.

Silica is indispensably blended in the rubber composition constituting the cap tread layer 11. Examples of the silica that can be used include w et silica (hydrous silicic acid), dry silica (silicic anhydride), calcium silicate, and aluminum silicate. One type of these silicas may be used alone, or a combination of two or more types of these silicas may be used. Surface-treated silica, in which the surface of silica is treated with a silane coupling agent, may also be used. By the blending of the silica, rubber hardness of the rubber composition can be increased, and excellent dry performance (steering stability) can be achieved when a pneumatic tire is formed. The blended amount of the silica is from 60 parts by mass to 90 parts by mass, and preferably from 70 parts by mass to 80 parts by mass, per 100 parts by mass of the diene rubber described above. When the blended amount of the silica is less than 60 parts by mass, wet performance deteriorates. When the blended amount of the silica is more than 90 parts by mass, rolling resistance cannot be reduced.

A CTAB (cetyltrimethylammonium bromide) adsorption specific surface area of the silica is not particularly limited but is preferably from 150 m²/g to 220 m²/g, and more preferably from 160 m²/g to 200 m²/g. Setting the CTAB adsorption specific surface area of the silica to 150 m²/g or greater allows wet performance to be ensured. Furthermore, setting the CTAB adsorption specific surface area of the silica to 220 m²/g or less allows dry performance and wet performance to be improved and rolling resistance to be reduced. In an embodiment of the present technology, the CTAB adsorption specific surface area of silica is a value measured in accordance with ISO (International Organization for Standardization) 5794.

In an embodiment of the present technology, in addition to the silica, carbon black may be blended as an inorganic filler. By the blending of the carbon black, rubber hardness of the rubber composition can be increased, and excellent dry performance (steering stability) can be achieved when a pneumatic tire is formed. The blended amount of the carbon black is preferably from 5 parts by mass to 15 parts by mass, and more preferably from 5 parts by mass to 10 parts by mass, per 100 parts by mass of the diene rubber described above. When the blended amount of the carbon black is less than 5 parts by mass, dry performance deteriorates. When the blended amount of the carbon black is more than 15 parts by mass, low rolling resistance deteriorates. As the carbon black, for example, carbon black having a nitrogen adsorption specific surface area (N₂SA) of preferably 90 m²/g to 130 m²/g, and more preferably 110 m²/g to 120 m²/g, can be used. When the nitrogen adsorption specific surface area of the carbon black is less than 90 m²/g, dry performance cannot be adequately improved. When the nitrogen adsorption specific surface area of the carbon black is more than 130 m²/g, rolling resistance cannot be adequately reduced. In an embodiment of the present technology, the nitrogen adsorption specific surface area of carbon black is a value measured in accordance with JIS K 6217-2.

The rubber composition constituting the cap tread layer 11 can contain another filler besides the silica and the carbon black described above. Examples of the other fillers include calcium carbonate, magnesium carbonate, talc, clay, alumina, aluminum hydroxide, titanium oxide, and calcium sulfate. One type of these other fillers may be used alone, or a combination of two or more types of these other fillers may be used.

In the rubber composition constituting the cap tread layer 11, a silane coupling agent is preferably blended together with the silica described above. The silane coupling agent can improve the dispersibility of the silica. The blended amount of the silane coupling agent is preferably from 7 mass % to 10 mass %, and more preferably from 8 mass % to 9 mass %, of the silica. When the blended amount of the silane coupling agent is less than 7 mass %, dispersibility of the silica may not be adequately improved. When the blended amount of the silane coupling agent is more than 10 mass %, premature vulcanization tends to occur in the rubber composition, and the forming processability tends to be degraded.

The silane coupling agent is not particularly limited as long as the silane coupling agent can be used for a rubber composition for a tire. Examples thereof include sulfur-containing silane coupling agents such as bis(3-triethoxysilylpropyl)tetrasulfide, bis(3-triethoxysilylpropyl)disulfide, 3-trimethoxysilylpropyl benzothiazoletetrasulfide, γ-mercaptopropyl triethoxysilane, and 3-octanoylthiopropyl triethoxysilane. Among these, the silane coupling agent having a mercapto group is preferred, and the affinity to silica can be enhanced, and the dispersibility can be improved. One type of these silane coupling agents can be blended alone, or a combination of multiple types of these can be blended.

In the rubber composition constituting the undertread layer 12, the rubber component contains indispensably two or more types selected from the group consisting of a natural rubber, a styrene-butadiene rubber, an isoprene rubber, and a butadiene rubber, and the total of these are set to 100 mass %. Two types that are a natural rubber and a butadiene rubber are preferably contained and, optionally, a styrene-butadiene rubber and/or an isoprene rubber is preferably contained. Configuring the undertread layer 12 as described above is advantageous for ensuring excellent dry performance (steering stability) due to cooperative action with the cap tread layer 11. That is, the cap tread rubber is advantageous for improving snow performance but may not adequately en sure dry performance; however, use of the undertread rubber described above supplements dry performance and enables a tire to provide these performances in a compatible manner.

As described above, in a case where the undertread layer 12 contains the two types that are the natural rubber and the butadiene rubber as main components and, optionally, the styrene-butadiene rubber and/or the isoprene rubber, per 100 mass % of the rubber component, preferably 50 mass % or greater, and more preferably from 60 mass % to 80 mass %, of the natural rubber is contained, and preferably 15 mass % or greater and 35 mass % or less, and more preferably from 20 mass % to 30 mass %, of the butadiene rubber is contained. In the undertread layer 12, when the blended amount of the natural rubber is less than 50 mass %, or when the blended amount of the butadiene rubber is less than 15 mass %, low rolling resistance deteriorates. When the blended amount of the butadiene rubber in the undertread layer 12 is more than 35 mass %, dry performance deteriorates.

As described above, in a case where the undertread layer 12 contains the two types that are the natural rubber and the butadiene rubber as main components and, optionally, the styrene-butadiene rubber and/or the isoprene rubber, the blended amounts of the optionally blended styrene-butadiene rubber and isoprene rubber are not particularly limited. However, to further improve the rubber physical property required for the undertread layer 12, the isoprene rubber is preferably blended such that the total amount of the isoprene rubber and the natural rubber is preferably 50 mass % or greater, and more preferably from 60 mass % to 80 mass %, per 100 mass % of the rubber component. Similarly, preferably from 5 mass % to 25 mass %, and more preferably from 10 mass % to 20 mass %, of the styrene-butadiene rubber is blended per 100 mass % of the rubber component.

The rubber composition constituting the undertread layer 12 preferably contains silica and/or carbon black as inorganic fillers. Blending of the silica and/or the carbon black increases the rubber hardness. In a case where the rubber composition is used for the undertread layer 12 disposed on the inner circumferential side of the cap tread layer 11 described above, excellent dry performance (steering stability) can be ensured due to cooperative action with the cap tread layer 211. The blended amount of the silica and/or the carbon black in the undertread layer 12 is preferably 50 parts by mass or greater, and more preferably from 55 parts by mass to 65 parts by mass, per 100 parts by mass of the rubber component described above. When the blended amount of the silica and/or the carbon black in the undertread layer 12 is less than 50 parts by mass, dry performance deteriorates.

Examples of the silica used in the undertread layer 12 include wet silica (hydrous silicic acid), dry silica (silicic anhydride), calcium silicate, and aluminum silicate. One type of these silicas may be used alone, or a combination of two or more types of these silicas may be used. Surface-treated silica, in which the surface of silica is treated with a silane coupling agent, may also be used. A CTAB adsorption specific surface area of the silica is not particularly limited but is preferably from 130 m²/g to 175 m²/g, and more preferably from 138 m²/g to 168 m²/g. Setting the CTAB adsorption specific surface area of the silica to 130 m²/g or greater allows wet performance to be ensured. Furthermore, setting the CTAB adsorption specific surface area of the silica to 175 m²/g or less allows dry performance and wet performance to be improved and rolling resistance to be reduced. In an embodiment of the present technology, the CTAB adsorption specific surface area of silica is a value measured in accordance with ISO 5794.

As the carbon black used in the undertread layer 12, for example, carbon black having a nitrogen adsorption specific surface area (N₂SA) of preferably 40 m²/g to 100 m²/g, and more preferably 80 m²/g to 100 m²/g, can be used. When the nitrogen adsorption specific surface area of the carbon black is less than 40 m²/g, dry steering stability performance cannot be adequately improved. When the nitrogen adsorption specific surface area of the carbon black is more than 100 m²/g, rolling resistance cannot be adequately reduced. In an embodiment of the present technology, the nitrogen adsorption specific surface area of carbon black is a value measured in accordance with JIS K 6217-2.

The rubber composition constituting the undertread layer 12 can contain another filler besides the silica and the carbon black described above. Examples of the other fillers include calcium carbonate, magnesium carbonate, talc, clay, alumina, aluminum hydroxide, titanium oxide, and calcium sulfate. One type of these other fillers may be used alone, or a combination of two or more types of these other fillers may be used.

In the rubber composition constituting the undertread layer 12, a silane coupling agent is preferably blended together with the silica described above. The silane coupling agent can improve the dispersibility of the silica. The blended amount of the silane coupling agent is preferably from 7 mass % to 10 mass %, and more preferably from 8 mass % to 9 mass %, of the silica. When the blended amount of the silane coupling agent is less than 7 mass %, dispersibility of the silica may not be adequately improved. When the blended amount of the silane coupling agent is more than 10 mass %, premature vulcanization tends to occur in the rubber composition, and the forming processability tends to be degraded. As the silane coupling agent used in the rubber composition constituting the undertread layer 12, various silane coupling agents that can be used for the cap tread layer 11 described above can be used. One type of the silane coupling agents can be blended alone, or a combination of multiple types of these can be blended.

In an embodiment of the present technology, the rubber composition constituting the cap tread layer 11 and the rubber composition constituting the undertread layer 12 may contain various additives, such as a vulcanization or crosslinking agent, a vulcanization accelerator, various oils, an anti-aging agent, and a plasticizer, that are typically used for rubber compositions for tires besides the compounding agents described above in a range that does not impair the object of the present technology. These additives can be kneaded by a typical method to form a rubber composition to be used for vulcanization or crosslinking. The blended amounts of these additives may be known typical blended amounts without departing from the object of the present technology. The rubber composition for a tire can be produced by mixing each component described above by using a common rubber kneading machine such as a Banbury mixer, a kneader, and a roll.

In the tire according to an embodiment of the present technology using the rubber composition having the compounding proportions described above, when the hardness of the cap tread rubber constituting the cap tread layer 11 at 20° C. is a hardness Hc and the hardness of the undertread rubber constituting the undertread layer 12 at 20° C. is a hardness Hu, the hardness Hc of the cap tread rubber is 63 or greater and 67 or less, and preferably 64 or greater and 66 or less, and the hardness Hu of the undertread rubber is preferably 75 or greater and 80 or less, and more preferably 77 or greater and 79 or less. Furthermore, the hardness Hc of the cap tread rubber and the hardness Hu of the undertread rubber satisfy the relationship Hu>Hc, and the difference ΔH of these hardnesses (=Hu−Hc) is 10 or more, and preferably 10 or more and 13 or less. Setting the relationship of the hardnesses as described above allows snow performance to be improved.

When the hardness Hc of the cap tread rubber at this time is less than 63, dry performance cannot be improved because, in the tire, the cap tread layer 11 in contact with the road surface is too soft. When the hardness Hc of the cap tread rubber is more than 67, snow performance cannot be improved. When the hardness Hu of the undertread rubber is less than 75, dry performance cannot be improved. When the hardness Hu of the undertread rubber is more than 80, wet performance cannot be improved. When the magnitude relationship of the hardness Hc of the cap tread rubber and the hardness Hu of the undertread rubber is reversed, dry performance, wet performance, and snow performance cannot be improved. When the hardness difference ΔH is less than 10, the cap tread rubber and the undertread rubber have substantially the same degree of hardness, and thus dry performance, wet performance, and snow performance cannot be improved. For example, in a case where the snow performance is ensured by adequately unhardening the cap tread layer 11, the undertread layer 12 is adequately hardened to ensure dry performance; however, a small hardness difference ΔH makes dry performance difficult to be ensured by the undertread layer 12.

In addition to having the hardness described above, the cap tread rubber constituting the cap tread layer 11 has a storage modulus E′ at −20° C. of preferably 70 MPa or less, and more preferably from 60 MPa to 68 MPa. Setting the storage modulus E′ as described above is advantageous for improving snow performance. When the storage modulus E′ of the cap tread rubber is more than 70 MPa, snow performance cannot be improved.

The physical properties described above related to the rubber composition constituting the cap tread layer 11 and the undertread layer 12 can be achieved by employing the above-mentioned compounding proportions of the rubber composition constituting each of the layers. Alternatively, the physical properties described above can be appropriately set by adjusting the blended amount of process oil, sulfur, and the like besides the compounding agents for which specific blended amount ranges have been described.

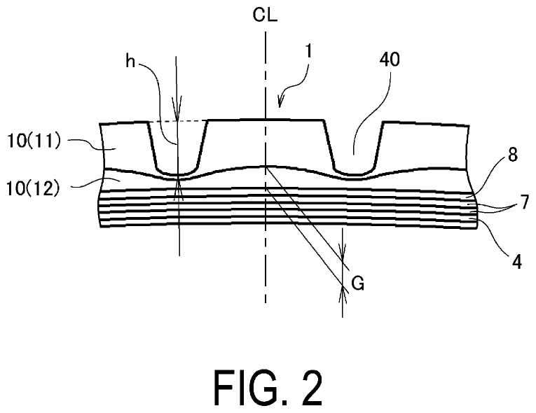

When the cap tread layer 11 and the undertread layer 12 described above are employed, from the perspective of achieving desired tire performance, the thickness of each of the layers is preferably set properly. Specifically, a ratio h/G of a block height h to a thickness G of the undertread layer 12 is set to be preferably from 9 to 12, and more preferably from 9 to 11. When the ratio h/G is less than 9, snow performance cannot be improved. When the ratio h/G is more than 12, low rolling performance cannot be improved. Note that, as illustrated in FIG. 2, the block height h is a distance (maximum value) measured from a groove bottom of a groove 40 formed in the tread portion 1 to a road contact surface of the tread portion 1 along the perpendicular line to the road contact surface of the tread portion 1. The thickness G of the undertread layer 12 is a distance (maximum value) measured from an outer surface of a reinforcing layer positioned on an outermost circumferential side of the reinforcing layers (belt layers 7 or belt cover layers 8) provided in the tire to a boundary between the cap tread layer 11 and the undertread layer 12 along the perpendicular line to the outer surface of the reinforcing layer.

An embodiment of the present technology will further be described below by way of Examples, but the scope of an embodiment of the present technology is not limited to Examples.

### Examples

Pneumatic tires (test tires) having the basic structure illustrated in FIG. 1 and a tire size of 285/60R18 116V were manufactured by using, for the cap tread layer (cap tread rubber), 16 types of rubber compositions for tires (Standard Example 1, Comparative Examples 1 to 8, and Examples 1 to 7), which have the compounding proportions listed in Table 1. In preparation of these 16 types of rubber compositions for tires, compounding ingredients other than a vulcanization accelerator and sulfur were weighed and kneaded in a 1.8 L sealed Banbury mixer for 5 minutes. Then, a master batch was discharged and cooled at room temperature. Thereafter, the master batch was added into the 1.8 L sealed Banbury mixer, and the vulcanization accelerator and sulfur were added and mixed for two minutes to obtain the 16 types of rubber compositions for tires.

The physical properties listed in Table 1 were measured by using a vulcanized rubber test piece made of each of the rubber compositions for tires. The test piece was produced by vulcanizing each of the 16 types of rubber compositions for tires at 145° C. for 35 minutes in a mold having a predetermined shape. Specifically, “hardness Hc” means a hardness of the cap tread rubber at 20° C. and is a value measured with a Type A durometer at a temperature of 20° C. in accordance with JIS K 6253. Furthermore, “E′ (−20° C.)” means a storage modulus at −20° C. and is a value measured by using a viscoelastic spectrometer under the conditions of an elongation deformation strain of 10±2%, a vibration frequency of 20 Hz, and −20° C.

In each of the test tires, an undertread rubber listed in the row of “type of undertread” in Table 1 was used as the undertread rubber constituting the undertread layer. Specifically, any one of undertread rubbers A to C having the compounding proportions listed in Table 2 was used. In the table, the hardness of the undertread rubber at 20° C. (“hardness Hu” in the table) was also listed in addition to the compounding proportions. “Hardness Hu” was a value measured at a temperature of 20° C. by using a type A durometer in accordance with JIS K 6253. “Hardness difference ΔH” in Table 1 is a difference between the “hardness Hc” and the “hardness Hu” (ΔH=Hu−Hc).

In all the test tires, the block height h from a groove bottom of a groove formed in the tread portion to a road contact surface of the tread portion was 10 mm, the thickness G of the undertread layer was 1 mm, and the ratio h/G was 10.

For each of the test tires, snow performance, dry performance, wet performance, and rolling resistance were evaluated by the following methods.

### Snow Performance

Each of the test tires was assembled on a JATMA (The Japan Automobile Tyre Manufacturers Association, Inc.) standard rim wheel having a rim size of 18×8J, inflated to an air pressure of 230 kPa, and mounted on a test vehicle, which was a four wheel drive SUV (sport utility vehicle) vehicle. Braking was performed from a traveling condition at a speed of 40 km/h on an icy and snowy road surface, and a braking distance until the test vehicle came to a complete stop was measured. The evaluation results are expressed as index values using the reciprocal of the measurement values, with the Standard Example 1 being assigned the index of 100. Larger index values indicate shorter braking distance and excellent braking performance on icy and snowy road surfaces (snow performance).

### Dry Performance

Each of the test tires was assembled on a JATMA standard rim wheel having a rim size of 18×8J, inflated to an air pressure of 230 kPa, and mounted on a test vehicle, which was a four wheel drive SUV vehicle. A sensory evaluation for steering stability was performed by test drivers on a dry paved road surface. The evaluation results are expressed as index values with the value of Standard Example 1 being assigned 100. Larger index values indicate superior steering stability on dry road surfaces (dry performance).

### Wet Performance

Each of the test tires was assembled on a JATMA standard rim wheel having a rim size of 18×8J, inflated to an air pressure of 230 kPa, and mounted on a test vehicle, which was a four wheel drive SUV vehicle. Braking was performed from a traveling condition at a speed of 100 km/h on a wet road surface, and a braking distance until the test vehicle came to a complete stop was measured. The evaluation results are expressed as index values using the reciprocal of the measurement values, with the Standard Example 1 being assigned the index of 100. Larger index values indicate shorter braking distance and excellent braking performance on wet road surfaces (wet performance).

### Low Rolling Performance

Each of the test tires was assembled on a JATMA standard rim wheel having a rim size of 18×8J. Rolling resistance was measured in accordance with ISO 28580 using a drum testing machine having a drum diameter of 1707.6 mm under the conditions of an air pressure of 240 kPa, a load of 4.82 kN, and a speed of 80 km/h. The evaluation results are expressed as index values using the reciprocal of the measurement values, with the Standard Example 1 being assigned the index of 100. Larger index values indicate lower rolling resistance and excellent low rolling performance.

TABLE 1

| | | Standard | Example | Example | Example |
|---|---|---|---|---|---|
| | | Example 1 | 1 | 2 | 3 |
| NR | Parts by mass | 35 | 20 | 20 | 20 |
| SBR 1 | Parts by mass | 40 | 60 | | 60 |
| SBR 2 | Parts by mass | | | 60 | |
| BR1 | Parts by mass | | 20 | 20 | |
| BR2 | Parts by mass | | | | 20 |
| BR3 | Parts by mass | 25 | | | |
| BR4 | Parts by mass | | | | |
| Silica | Parts by mass | 80 | 70 | 70 | 70 |
| CB | Parts by mass | 5 | 5 | 5 | 5 |
| Silane coupling agent | Parts by mass | 6.4 | 5.6 | 5.6 | 5.6 |
| Aroma oil | Parts by mass | 10 | 5 | 5 | 5 |
| Stearic acid | Parts by mass | 2 | 2 | 2 | 2 |
| Zinc oxide | Parts by mass | 3 | 3 | 3 | 3 |
| Anti-aging agent | Parts by mass | 4 | 4 | 4 | 4 |
| Sulfur | Parts by mass | 1 | 1 | 1 | 1 |
| Vulcanization accelerator 1 | Parts by mass | 2 | 2 | 2 | 2 |
| Vulcanization accelerator 2 | Parts by mass | 1 | 2 | 2 | 2 |
| Hardness Hc | | 70 | 64 | 64 | 64 |
| Type of undertread | | C | A | A | A |
| Hardness difference ΔH | | −10 | 13 | 13 | 13 |
| E′ (−20° C.) | MPa | 70 | 60 | 60 | 60 |
| Snow performance | Index value | 100 | 105 | 105 | 105 |
| Dry performance | Index value | 100 | 105 | 104 | 102 |
| Wet performance | Index value | 100 | 105 | 107 | 109 |
| Low rolling performance | Rating | 100 | 105 | 108 | 107 |
| | | Example | Comparative | Comparative | Comparative |
| | | 4 | Example 1 | Example 2 | Example 3 |
| NR | Parts by mass | 25 | 10 | 20 | 50 |
| SBR 1 | Parts by mass | 30 | 75 | 30 | 30 |
| SBR 2 | Parts by mass | | | | |
| BR1 | Parts by mass | 45 | 15 | 50 | 20 |
| BR2 | Parts by mass | | | | |
| BR3 | Parts by mass | | | | |
| BR4 | Parts by mass | | | | |
| Silica | Parts by mass | 80 | 70 | 70 | 70 |
| CB | Parts by mass | 5 | 5 | 5 | 5 |
| Silane coupling agent | Parts by mass | 6.4 | 5.6 | 5.6 | 5.6 |
| Aroma oil | Parts by mass | 5 | 5 | 5 | 5 |
| Stearic acid | Parts by mass | 2 | 2 | 2 | 2 |
| Zinc oxide | Parts by mass | 3 | 3 | 3 | 3 |
| Anti-aging agent | Parts by mass | 4 | 4 | 4 | 4 |
| Sulfur | Parts by mass | 1 | 1 | 1 | 1 |
| Vulcanization | Parts by mass | 2 | 2 | 2 | 2 |
| accelerator 1 | | | | | |
| Vulcanization | Parts by mass | 2 | 2 | 2 | 2 |
| accelerator 2 | | | | | |
| Hardness Hc | | 67 | 64 | 64 | 64 |
| Type of undertread | | A | A | A | A |
| Hardness difference ΔH | | 10 | 13 | 13 | 13 |
| E′ (−20° C.) | MPa | 52 | 80 | 45 | 58 |
| Snow performance | Index value | 108 | 97 | 112 | 106 |
| Dry performance | Index value | 104 | 111 | 100 | 100 |
| Wet performance | Index value | 100 | 108 | 97 | 96 |
| Low rolling | Rating | 103 | 103 | 102 | 97 |
| performance | | | | | |
| | | Comparative | Comparative | Comparative | Comparative |
| | | Example 4 | Example 5 | Example 6 | Example 7 |
| NR | Parts by mass | 20 | 20 | 20 | 20 |
| SBR 1 | Parts by mass | 60 | 60 | 60 | 60 |
| SBR 2 | Parts by mass | | | | |
| BR1 | Parts by mass | 20 | 20 | 20 | |
| BR2 | Parts by mass | | | | |
| BR3 | Parts by mass | | | | 20 |
| BR4 | Parts by mass | | | | |
| Silica | Parts by mass | 95 | 70 | 70 | 70 |
| CB | Parts by mass | 5 | 5 | 5 | 5 |
| Silane coupling | Parts by mass | 7.6 | 5.6 | 5.6 | 5.6 |
| agent | | | | | |
| Aroma oil | Parts by mass | 25 | 5 | 10 | 10 |
| Stearic acid | Parts by mass | 2 | 2 | 2 | 2 |
| Zinc oxide | Parts by mass | 3 | 3 | 3 | 3 |
| Anti-aging agent | Parts by mass | 4 | 4 | 4 | 4 |
| Sulfur | Parts by mass | 2 | 2 | 2 | 1 |
| Vulcanization | Parts by mass | 2 | 2 | 2 | 2 |
| accelerator 1 | | | | | |
| Vulcanization | Parts by mass | 2 | 2 | 2 | 2 |
| accelerator 2 | | | | | |
| Hardness Hc | | 67 | 64 | 62 | 64 |
| Type of undertread | | A | B | A | A |
| Hardness difference | ΔH | 10 | 6 | 15 | 13 |
| E′ (−20° C.) | MPa | 70 | 60 | 55 | 60 |
| Snow performance | Index value | 100 | 105 | 108 | 110 |
| Dry performance | Index value | 105 | 98 | 96 | 102 |
| Wet performance | Index value | 110 | 105 | 105 | 104 |
| Low rolling | Rating | 98 | 105 | 104 | 98 |
| performance | | | | | |
| | | Comparative | Example | Example | Example |
| | | Example 8 | 5 | 6 | 7 |
| NR | Parts by mass | 20 | 15 | 30 | 20 |
| SBR 1 | Parts by mass | 60 | 70 | 40 | 60 |
| SBR 2 | Parts by mass | | | | |
| BR1 | Parts by mass | | 15 | 30 | 20 |
| BR2 | Parts by mass | | | | |
| BR3 | Parts by mass | | | | |
| BR4 | Parts by mass | 20 | | | |
| Silica | Parts by mass | 70 | 70 | 70 | 90 |
| CB | Parts by mass | 5 | 5 | 5 | 5 |
| Silane coupling agent | Parts by mass | 5.6 | 5.6 | 5.6 | 7.2 |
| Aroma oil | Parts by mass | 10 | 5 | 5 | 5 |
| Stearic acid | Parts by mass | 2 | 2 | 2 | 2 |
| Zinc oxide | Parts by mass | 3 | 3 | 3 | 3 |
| Anti-aging agent | Parts by mass | 4 | 4 | 4 | 4 |
| Sulfur | Parts by mass | 1 | 1 | 1 | 1 |
| Vulcanization accelerator 1 | Parts by mass | 2 | 2 | 2 | 2 |
| Vulcanization accelerator 2 | Parts by mass | 2 | 2 | 2 | 2 |
| Hardness Hc | | 64 | 64 | 64 | 66 |
| Type of undertread | | A | A | A | A |
| Hardness difference ΔH | | 13 | 13 | 13 | 11 |
| E′ (−20° C.) | MPa | 65 | 65 | 63 | 65 |
| Snow performance | Index value | 102 | 102 | 107 | 102 |
| Dry performance | Index value | 97 | 108 | 104 | 103 |
| Wet performance | Index value | 97 | 106 | 102 | 108 |
| Low rolling performance | Rating | 105 | 105 | 106 | 100 |

Types of raw materials used as indicated in Table 1 are described below.
NR: Natural rubber, SIR20, available from PT. Kirana Sapta
SBR 1: Terminal-modified styrene-butadiene rubber, Tufdene E581, available from Asahi Kasei Chemicals Corporation (modification group: glycidyl group; vinyl content: 38 mass %)
SBR 2: Terminal-modified styrene-butadiene rubber, Tufdene F3420, available from Asahi Kasei Chemicals Corporation (modification group: aminosilane group; vinyl content: 38 mass %)
BR1: Butadiene rubber modified with ahydrocarbyloxysilane compound, BR54, available from JSR Corporation (functional group: silanol group; cis-1,4 bond content: 98 mol %)
BR2: Butadiene rubber modified with a poly organosiloxane group, BR1261, available from Zeon Corporation (functional group: polyorganosiloxane; cis-1,4 bond content: 35 mol %)
BR3: Unmodified butadiene rubber, Nipol 1220, available from Zeon Corporation (cis-1,4 bond content: 96 mol %)
BR4: Butadiene rubber modified with N-methylpyrrolidone, BR1250H, available from Zeon Corporation (functional group: N-methylpyrrolidone; cis-1,4 bond content: 35 mol %)
Silica: ULTRASIL 9100 GR, available from Evonik Industries AG
CB: Carbon black, VULCAN MS, available from Cabot Japan K.K.
Silane coupling agent: Si69, available from Evonik Degussa
Aroma oil: Extract No. 4S, available from Showa Shell Sekiyu K.K.
Stearic acid: Beads stearic acid, available from NOF Corporation
Zinc oxide: Zinc Oxide III, available from Seido Chemical Industry Co., Ltd.
Anti-aging agent: 6PPD, available from Korea Kumho Petrochemical
Sulfur: Golden Flower oil treated sulfur powder, available from Tsurumi Chemical Industry Co., Ltd.
Vulcanization accelerator 1: NOCCELER CZ-G, available from Ouchi Shinko Chemical Industrial Co., Ltd.
Vulcanization accelerator 2: Soxinol D-G, available from Sumitomo Chemical Co., Ltd.

TABLE 2

| | | Undertread | Undertread | Undertread |
|---|---|---|---|---|
| | | rubber A | rubber B | rubber C |
| NR | Parts by mass | 65 | 65 | 80 |
| SBR | Parts by mass | 15 | 15 | |
| BR | Parts by mass | 25 | 25 | 20 |
| Silica | Parts by mass | 15 | 10 | |
| CB | Parts by mass | 60 | 55 | 45 |
| Silane coupling agent | Parts by mass | 1.2 | 0.8 | |
| Aroma oil | Parts by mass | | 4 | 2 |
| Tackifying resin | Parts by mass | 2 | 2 | 2 |
| Stearic acid | Parts by mass | 2 | 2 | 2 |
| Zinc oxide | Parts by mass | 3 | 3 | 3 |
| Anti-aging agent | Parts by mass | 2 | 2 | 2 |
| Sulfur | Parts by mass | 2.5 | 2.2 | 3 |
| Vulcanization | Parts by mass | 1.5 | 1.5 | 1 |
| accelerator | Parts by mass | | | |
| Hardness Hu | Parts by mass | 77 | 77 | 60 |

The types of raw materials used as indicated in Table 2 are described below.
NR: Natural rubber, SIR20, available from PT. Kirana Sapta
BR2: Butadiene rubber, Nipol 1220, available from Zeon Corporation (cis-1,4 bond content: 96 mol %)
SBR: Styrene-butadiene rubber, Nipol 1502, available from Zeon Corporation
Silica: ULTRASIL 9100 GR, available from Evonik Industries AG
CB: Carbon black, VULCAN 7HJ, available from Cabot Japan K.K.
Silane coupling agent: Si69, available from Evonik Degussa
Aroma oil: Extract No. 4S, available from Showa Shell Sekiyu K.K.
Stearic acid: Beads stearic acid, available from NOF Corporation
Zinc oxide: Zinc Oxide III, available from Seido Chemical Industry Co., Ltd.
Anti-aging agent: 6PPD, available from Korea Kumho Petrochemical
Sulfur: Golden Flower oil treated sulfur powder, available from Tsurumi Chemical Industry Co., Ltd.
Vulcanization accelerator: NOCCELER CZ-G, available from Ouchi Shinko Chemical Industrial Co., Ltd.

As can be seen from Table 1, each of the pneumatic tires of Examples 1 to 7 ensured snow performance, dry performance, wet performance, and low rolling performance that were the same degree as or better than those of Standard Example 1, and these performances were provided in a well-balanced, highly compatible manner. On the other hand, since Comparative Example 1 had a large blended amount of the styrene-butadiene rubber and a small blended amount of the butadiene rubber, snow performance was degraded. Since Comparative Example 2 had a small blended amount of the styrene-butadiene rubber and a large blended amount of the butadiene rubber, wet performance was degraded. Since Comparative Example 3 had a small blended amount of the styrene-butadiene rubber and a large blended amount of the natural rubber, wet performance and low rolling performance were degraded. Since Comparative Example 4 had a large blended amount of the silica, low rolling performance was degraded. Since Comparative Example 5 had a small hardness difference ΔH, dry performance was degraded. Since Comparative Example 6 had a low hardness Hc, dry performance was degraded. Since Comparative Example 7 contained the unmodified butadiene rubber, low rolling performance was degraded. In Comparative Example 8, since the butadiene rubber was modified with a substance other than the hydrocarbyloxysilane compound or the polyorganosiloxane (specifically, N-methylpyrrolidone), snow performance was degraded.

1-5. (canceled)

6. A pneumatic tire comprising:
a tread portion extending in a tire circumferential direction and having an annular shape;
a pair of sidewall portions disposed on both sides of the tread portion;
a pair of bead portions disposed on an inner side in a tire radial direction of the pair of sidewall portions;
a carcass layer mounted between the pair of bead portions; and
a plurality of reinforcing layers disposed on an outer circumferential side of the carcass layer in the tread portion;
the tread portion having a bilayer structure comprising an undertread layer disposed on an outer circumferential side of the reinforcing layer and a cap tread layer disposed on an outer circumferential side of the undertread layer and constituting a road contact surface of the tread portion;
the cap tread layer comprising a rubber composition containing from 60 parts by mass to 90 parts by mass of silica per 100 parts by mass of a diene rubber containing 15 mass % or greater and 30 mass % or less of a natural rubber, 40 mass % or greater and 70 mass % or less of a styrene-butadiene rubber, and 15 mass % or greater and 30 mass % or less of a butadiene rubber, a total of the natural rubber, the styrene-butadiene rubber, and the butadiene rubber being 100 mass %;
the styrene-butadiene rubber being a terminal-modified styrene-butadiene rubber having a vinyl content of from 35 mass % to 45 mass %;
the butadiene rubber being a modified butadiene rubber obtained by modifying an active terminal of a conjugated diene polymer with at least one functional group selected from the group consisting of a hydrocarbyloxysilane compound and a polyorganosiloxane;
a hardness Hu of an undertread rubber constituting the undertread layer at 20° C. and a hardness Hc of a cap tread rubber constituting the cap tread layer at 20° C. satisfying a relationship of Hu>Hc;
the hardness Hc being 63 or greater and 67 or less; and
a difference ΔH between the hardness Hu and the hardness Hc being 10 or more.

7. The pneumatic tire according to claim 6, wherein a cis-1,4 bond content in the butadiene rubber is 75 mol % or greater.

8. The pneumatic tire according to claim 6, wherein a storage modulus E′ of the cap tread rubber constituting the cap tread layer at −20° C. is 70 MPa or less.

9. The pneumatic tire according to claim 6, wherein
the undertread layer contains a rubber composition containing 70 parts by mass or greater of silica or carbon black per 100 parts by mass of a rubber component containing two or more types selected from the group consisting of a natural rubber, a styrene-butadiene rubber, an isoprene rubber, and a butadiene rubber, and
the hardness Hu is 75 or greater and 80 or less.

10. The pneumatic tire according to claim 6, wherein a ratio h/G of a block height h from a groove bottom of a groove formed in the tread portion to a road contact surface of the tread portion to a thickness G of the undertread layer is from 9 to 12.

11. The pneumatic tire according to claim 7, wherein a storage modulus E′ of the cap tread rubber constituting the cap tread layer at −20° C. is 70 MPa or less.

12. The pneumatic tire according to claim 11, wherein
the undertread layer contains a rubber composition containing 70 parts by mass or greater of silica or carbon black per 100 parts by mass of a rubber component containing two or more types selected from the group consisting of a natural rubber, a styrene-butadiene rubber, an isoprene rubber, and a butadiene rubber, and
the hardness Hu is 75 or greater and 80 or less.

13. The pneumatic tire according to claim 12, wherein a ratio h/G of a block height h from a groove bottom of a groove formed in the tread portion to a road contact surface of the tread portion to a thickness G of the undertread layer is from 9 to 12.
